(19) United States
(12) Patent Application Publication
(10) Pub. No.: US 2005/0140823 A1
(43) Pub. Date: Jun. 30, 2005

(54) Video camera

(75) Inventor: Shinichi Ishikuro, Hitachinaka (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: HITACHI, LTD., Tokyo (JP)

(21) Appl. No.: 11/007,393

(22) Filed: Dec. 7, 2004

(30) Foreign Application Priority Data
Dec. 25, 2003 (JP) 2003-428628

(51) Int. Cl. H04N 5/225

(52) U.S. Cl. 348/375

(57) ABSTRACT

A video camera comprises a lens unit to receive images to be captured; a display device to display the captured images; a main camera body; and one or more exterior decorative components, each being configured to be removed and replaced with a corresponding decorative component having different appearance, wherein one of the exterior decorative components includes a body and a first protrusion that extends outwardly from the body, and wherein the main camera body defines a first recess that is configured to receive the first protrusion.

### CROSS-REFERENCES TO RELATED APPLICATIONS

This application claims priority to Japanese Patent Application No. 2003-428628, filed on Dec. 25, 2003.

### BACKGROUND OF THE INVENTION

The present invention relates to a video cameral provided with replaceable external decorative members.

Color-variation development for electronic devices has been pursued extensively by various entities to produce electronic devices of the same model in different colors or to provide different exterior panels for electronic devices of the same model to enable users to select desired exterior panels, to satisfy the tastes and interests of different users.

The color-variation development has been successfully applied to portable telephones and the like, as described in JP-A No. 2002-125022 and JP-A No. 2003-143268. However, color-variation development has not been successfully applied to video cameras.

This is in part due to the different configuration used for typical video cameras when compared to mobile telephones as wells as the difference in mode of use. Therefore, a part-changing system that permits a user to change the exterior panels of a procured portable telephone cannot be directly applied to the video camera.

A typical video camera has a front unit provided with a lens mounting opening and a microphone, a liquid crystal display unit provided with a foldable, turnable liquid crystal display, a grip unit including a case containing a recording device, and a rear unit provided with a viewfinder and a battery mount. Each of these units has an exterior case and component parts contained in the exterior case. The component parts and the exterior cases are assembled and fastened together by fastening means, such as screws and/or adhesives.

A color-variation development for the video camera of the foregoing construction changes the colors of the exterior cases of the front unit and the liquid crystal display unit, which are conspicuous units (see, http://www.jvc-victor.co.jp/dvmain/gr-d200/index.html). Exterior cases of different colors are colored by painting in most cases. Exterior cases are colored by painting for color-variation development. When only some of the exterior cases are painted, whether or not painted parts can be seen is dependent on the shapes of the exterior cases and the overlying components, if any. Therefore, the painted exterior cases having complicated shapes may have an undesirable, complicated appearance.

A method for partial color-variation development is employed in solving such a problem. Generally, the method covers an exterior case with a painting mask and paints the exterior case partially through the painting mask. When the exterior cases are painted by this method, the appearance of the painted parts is not dependent on the shapes of the exterior cases and the exterior cases have an improved appearance. However, since the exterior cases of the video camera have complicated shapes, paint is liable to stick to parts covered with the painting mask. A conventional method of solving such a problem selects parts for color-variation development, forms parts separately, and attaches the separately formed parts to the exterior cases. For example, some method of color-variation development (see JP-A No. 7-43810) achieves its purpose by attaching metallic parts to a plurality of exterior cases to alter the feel of quality and appearance and to change color tone.

However, since the exterior parts are attached to the exterior cases with screws and adhesives during production, color-variation development is applied to the stage of production. Therefore, a user buying a camera is able to select merely a color and the feel of quality and is unable to change the color and the feel of quality of the camera after buying the camera.

### BRIEF SUMMARY OF THE INVENTION

The present invention provides a video camera including a plurality of exterior cases forming a camera body and at least one exterior decorative member. In one embodiment, the exterior decorative member includes or cooperates with an attaching mechanism that the decorative member to be securely attached to the video camera.

The exterior decorative member preferably is configured to be easily replaced with another decorative member without using special tools to enable the user change the appearance of the video camera.

In one embodiment, a video camera comprises a lens unit to receive images to be captured; a display device to display the captured images; a main camera body; and one or more exterior decorative components, each being configured to be removed and replaced with a corresponding decorative component having different appearance, wherein one of the exterior decorative components includes a body and a first protrusion that extends outwardly from the body, and wherein the main camera body defines a first recess that is configured to receive the first protrusion. The exterior decorative component has a second protrusion having a width of no more than 5 millimeter. The second protrusion has a backend that extends no more than 0.7 millimeter from a backend of the body of the one exterior component.

In another embodiment, a video camera comprises a lens unit to capture images; a display device to display the captured images; a main camera body; and at least one exterior decorative component that is configured to be removed and replaced with a corresponding decorative component having different appearance, wherein the at least one exterior decorative components includes a body and a first protrusion that extends outwardly from the body, wherein the main camera body defines a first recess that is configured to receive the first protrusion, and wherein the one exterior component defines a groove between the body of the exterior component and the first protrusion, the groove being configured to make the first protrusion less visible to human eyes.

In yet another embodiment, a lens cover for a video camera includes a body having a cylindrical upper portion and a lower portion; a holding projection extending outward from the lower portion of the body, the holding projection being configured to be received by a recess defined on a case of the video camera; a groove defined between the lower portion of the body and the holding projection to make the holding projection less visible when the holding projection is inserted into the recess of the case, wherein the lens cover is a removable, exterior decorative component of the video camera.

### BRIEF DESCRIPTION OF THE DRAWINGS

FIG. 1 is a front perspective view of a video camera according to one embodiment of the present invention.

FIG. 2 is a rear perspective view of a video camera according to one embodiment of the present invention.

FIG. 3 is a perspective view of a video camera with an LCD unfolded according to one embodiment of the present invention.

FIG. 4 is a front perspective view of assistance in explaining a lens cover attaching method according to one embodiment of the present invention.

FIG. 5 is a rear perspective view of assistance in explaining a lens cover attaching method according to one embodiment of the present invention.

FIG. 6 is an exploded perspective view of a video camera according to one embodiment of the present invention.

FIG. 7 is a fragmentary sectional view of a lens cover sliding structure according to one embodiment of the present invention.

FIG. 8 is a sectional view of a holding structure according to one embodiment of the present invention.

FIG. 9 is a sectional view of a holding structure and a locking structure according to one embodiment of the present invention.

FIG. 10A illustrates a holding projection without a groove according to one embodiment of the present invention.

FIG. 10B illustrates a holding projection with a groove to redirect reflecting lights according to one embodiment of the present invention.

FIG. 11A illustrates a side view of a holding projection according to one embodiment of the present invention.

FIG. 11B illustrates a side view of a holding projection having a wing according to one embodiment of the present invention.

FIG. 11C. illustrates a side view of a holding projection according to one embodiment of the present invention.

### DETAILED DESCRIPTION OF THE INVENTION

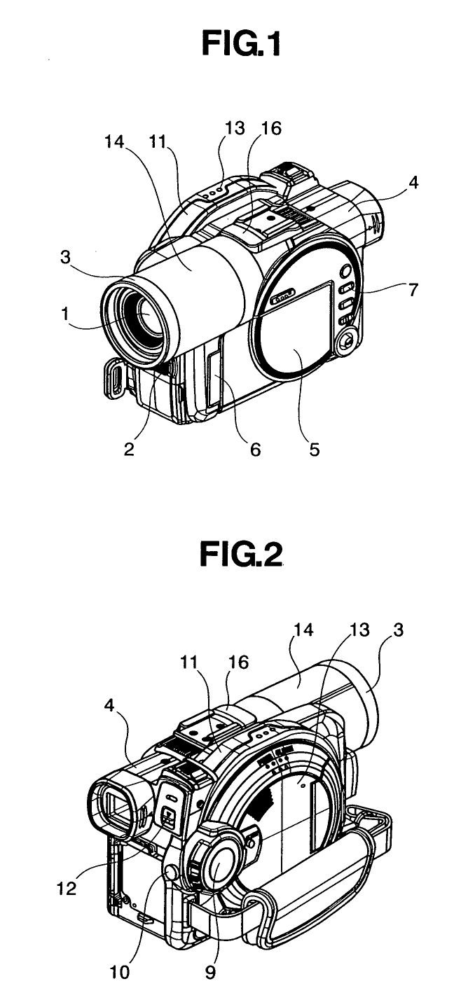

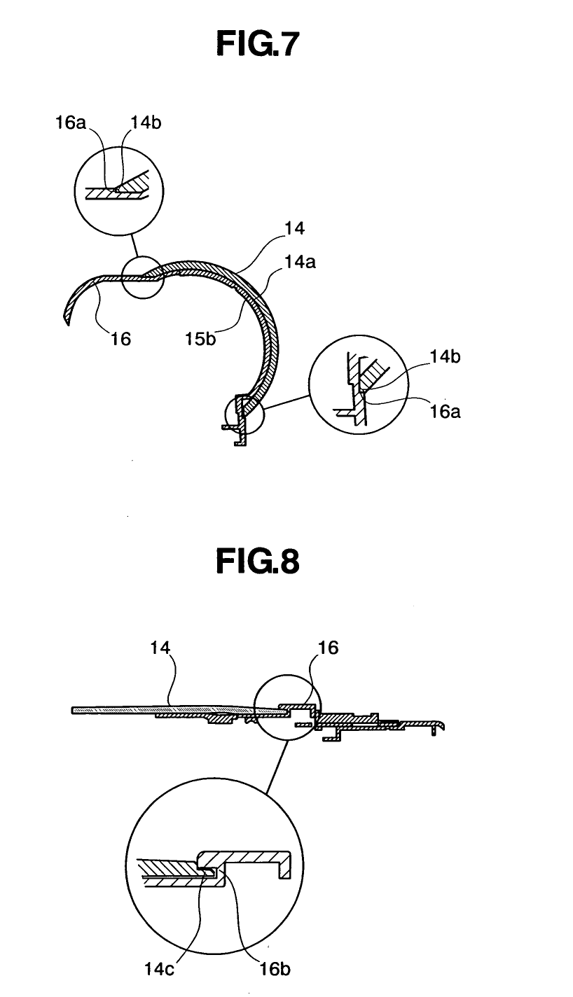

Video cameras in preferred embodiments according to the present invention will be described with reference to FIGS. 1 to 9.

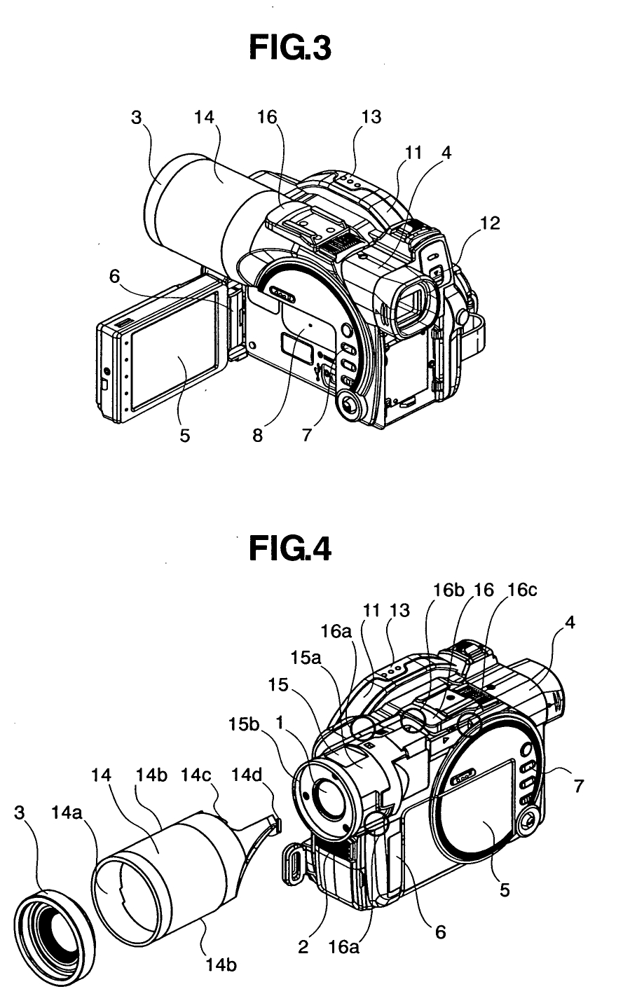

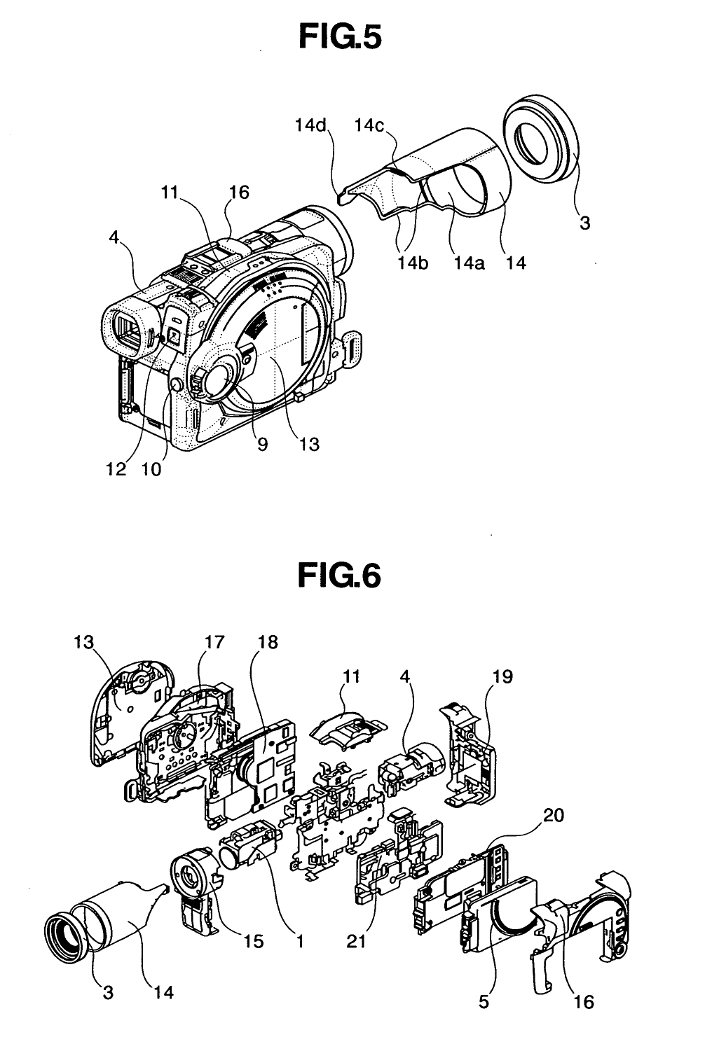

A video camera in a first embodiment according to the present invention will be described with reference to FIGS. 1 to 3 and 6. FIG. 1 is a front perspective view of the video camera, FIG. 2 is a rear perspective view of the video camera, FIG. 3 is a perspective view of the video camera in a state where an LCD (liquid crystal display) for displaying images taken by the video camera is unfolded, and FIG. 6 is an exploded perspective view of the video camera.

The video camera in the first embodiment has a front unit including a lens unit 1, a microphone unit 2, a lens cover 14, n, and a front case 15, and holding the lens cover 14. A liquid crystal display unit (or display device) includes an LCD 5, an LCD support 6, a main case 16, an L case 20 and a base plate 21. A grip unit includes a grip 11, a grip cover 13, a drive cover 17 and a drive unit 18. A rear unit includes an EVF (electric viewfinder) 4 and a rear cover 19. The lens cover 14 is illustrated as an exterior decorative component that may be replaced with other lens covers of different appearances.

Images are taken through the lens unit 1 and sounds are recorded by the microphone unit 2. A lens hood 3 mounted on a front part of the lens unit 1 can be attached to the front case 15 by a M37 screw mount specified in ISO 1948. The lens head (or cylindrical fastener) 3 has a cylindrical or ring shape in the present embodiment. When it is desired to change the optical ability of the lens unit 1, the hood 3 is removed from the lens unit 1, and an M37 conversion lens can be connected to the lens unit 1. The EVF 4 displays an image to be taken, and LCD 5 displays a reproduced image. The LCD support 6 supports the LCD 5 for turning, and the LCD can be set in an optional angular position suitable for use. Reproduction control buttons 7 to be operated principally for image-reproducing operations are arranged in an area adjacent to the folded LCD 5. Taking control buttons 8 to be operated principally for image-taking operations are arranged in an area that is exposed when the LCD 5 is unfolded. The LCD support 6 and the LCD 5 are put on the L case 20, and the main case 16 is put on the L case 20. A mode selector knob 9 is operated to turn on and off a power supply and to select either a moving-picture mode or a still-picture mode. A record button 10 is operated to start and stop a recording operation. The grip 11, the grip cover 13 and the drive cover 17, namely, exterior cases, protect a drive unit 18 for recording images in a recording medium. When changing the recording medium, an opening knob 12 is operated to open the grip cover 13 and the recording medium is replaced with another one.

The lens cover 14 is a replaceable exterior decorative member. The lens cover 14 protects the side surface of the lens unit 1. The lens cover 14 is a conspicuous member serving as a lens barrel, which is an exterior decorative member capable of effectively symbolizing the video camera. Thus, the conspicuous member enables color-variation development. The lens cover 14 is painted in an optional color or finished by a surface treatment, such as plating, for color-variation development. A plurality of kinds of lens covers 14 respectively having different appearances are available. The user is able to change the lens cover 14 to enjoy color variation. The lens cover 14 may be such as not finished by a surface treatment and formed by molding a semitransparent plastic material.

A lens cover attaching mechanism will be described with reference to FIGS. 4, 5 and 7. FIGS. 4, 5 and 7 are a front perspective view, a rear perspective view and a fragmentary sectional view showing a slide, respectively, of assistance in explaining a lens cover attaching method.

The lens cover 14 has a cylindrical front part 14a and a substantially straight, semicylindrical rear legs 14b. In putting the lens cover 14 on and taking the same off the front case 15, the front part 14a of an inside diameter corresponding to the outside diameter of cylindrical lens barrel of the front case 15 slides along the lens barrel of the front case 15, and the substantially straight, semicylindrical rear legs 14b slides along the exterior case. Thus, the lens cover 14 can be easily put on and taken off the exterior case.

The lens cover 14 is provided with holding projections 14c and 14d which engage with the main case 16. The front case 15 has a cylindrical front part 15a and an M37 screw mount 15b on which the hood 3 is mounted. The main case 16 is provided with longitudinal steps 16a along which the semicylindrical rear legs 14b slide, and recesses 16b and 16c in which the holding projections 14c and 14d engage, respectively.

The lens cover 14 is combined with the main case 16 by sliding the lens cover 14 along the main case 16. The cylindrical front part 14a of the lens cover 14 slides along the cylindrical front part 15a of the front case 15, and the substantially straight, semicylindrical rear legs 14b of the lens cover 14 is fit along the longitudinal steps 16a of the main case 16. The longitudinal steps 16a determine the angular position of the lens cover 14 relative to the main case 16, and serve as guides for guiding the rear legs 14b of the lens cover 14. The lens cover 14 can be easily put on and taken off the main case 16 simply by sliding the lens cover 14 along the longitudinal steps 16a.

At the final stage of the sliding movement of the lens cover 14 in putting the lens cover 14 on the main case 16, the holding projections (or protrusions) 14c and 14d engages in the recesses 16b and 16c so that the lens cover 14 may not easily fall off the main case 16.

After the lens cover 14 has been mounted on the main case 16, the hood 3 is mounted on the M37 screw mount 15b of the front case 15. The M37 screw mount 15b enables mounting the hood 3 on and dismounting the same from the front case 15 simply by turning the hood 3 in one direction and the opposite direction, respectively, without using any tool. The hood 3 has an outside diameter greater than the inside diameter of the lens cover 14. The hood 3 attached to the front case 15 is contiguous with the lens cover 14, restrains the lens cover 14 from axial movement and holds the lens cover 14 in place on the main case 16. Thus, the lens cover 14 can be mounted on the main case 16 without using any tool and can be held on the main case 16 without using any special fastening means, such as screws or an adhesive. Consequently, the lens cover 14 can be easily replaced with another one. The lens cover 14 can be thus firmly held in place as compared with being held in place merely by the engagement of projections and recesses. Even if a force acts on the lens cover 14 in an axially outward direction while the video camera in this embodiment is being carried in a bag, the lens cover 14 will not come off the main case 16, may not be lost or may not be damaged.

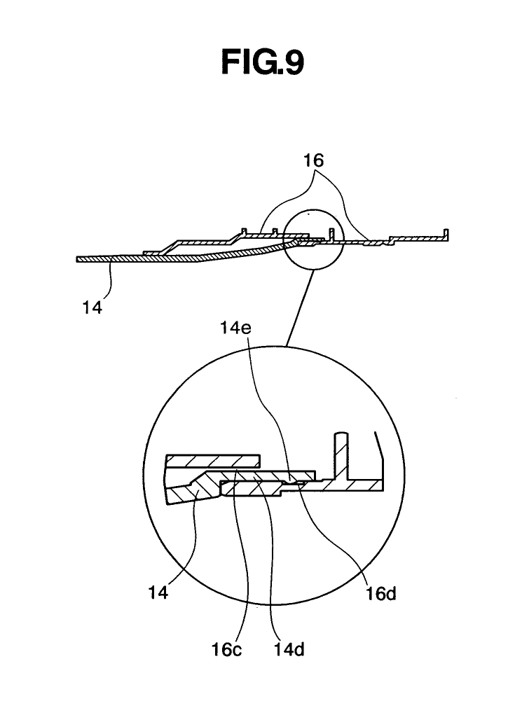

The construction of a joint will be described with reference to FIGS. 8 and 9. FIGS. 8 and 9 are a sectional view of a joint and a sectional view of a joint and a locking structure, respectively.

In FIG. 8, the holding projection 14c is engaged in the recess 16b to hold the semicylindrical rear leg on the main case 16. As shown in FIG. 9, the holding projection 14d and the recess 16c are formed such that the semicylindrical rear legs do not separate from the main case 16. The holding projection 14d is provided with a locking protrusion 14e. When the rear leg is inserted in the recess 16c, the locking protrusion 14e comes into contact with the main case 16. Since the holding projection 14d is elastic, the elastic holding projection 14d bends as the holding projection 14d engages in the recess 16c of the main case 16, and the locking protrusion 14e falls elastically in a locking recess 16d formed in the recess 16c. Thus, the user is able to replace the lens cover 14 with another one without using any special tool.

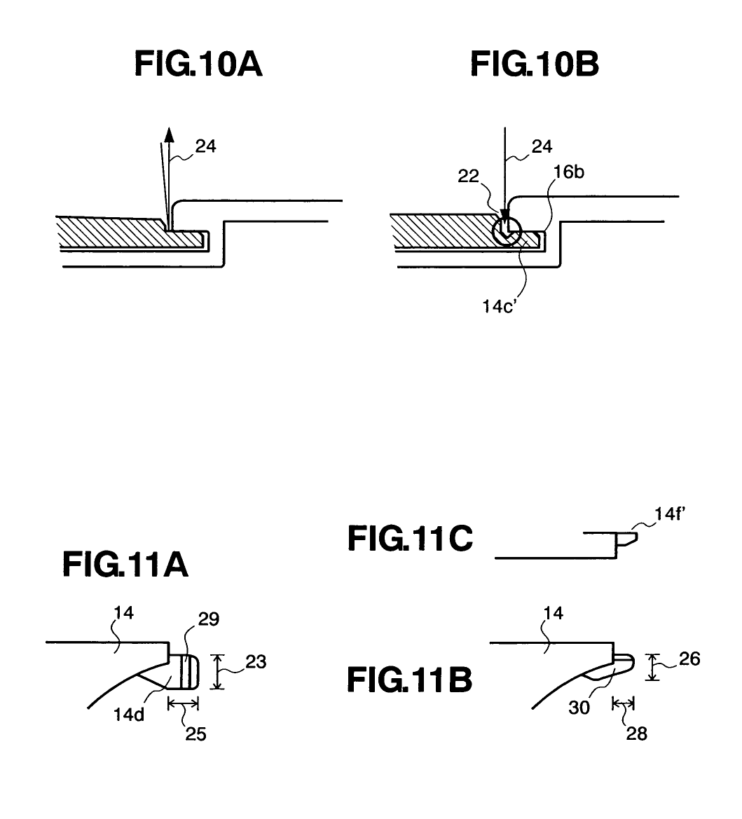

Referring to FIGS. 10A and 10B, a groove 22 is formed on the holding projection 14c′ to make the holding projection 14c′ that slides into the recess 16b to make the inserted holding projection less visible to human eyes according to one embodiment. Such a groove is particularly useful if the holding projection has a different color than the surrounding main camera body. The groove 22 prevents light beams 24 entering into a crevice defined by the main body and holding projection from reflecting out perpendicularly. That is, the groove redirects the light beams, so that they are not reflected out with a perpendicular angle (or substantially perpendicular angle). Without the groove, the lights would reflect outward perpendicularly, as shown in FIG. 10A.

With the groove 22, as shown in FIG. 10B, part of the light beams 24 is trapped and absorbed therein and part of the light beams is provided with a non-perpendicular reflection angle. Accordingly, the portion of the light beams reflected out at a perpendicular angle is substantially reduced, so that the holding projection 14c′ inserted into the recess is made less visible, thereby providing the video camera with a more aesthetic look. The groove 22 is formed between the body of the lens cover 14 and the holding projection. The groove is a V-shaped slot in the present embodiment.

In FIG. 9, the lens cover 14 can be removed from the main case 16 by reversing the steps of mounting the lens cover 14 on the main case 16. More specifically, the hood 3 is removed from the M37 screw mount 15b and the lens cover 14 is pulled axially away from the main case 16. Then, the elastic holding projection 14d provided with the locking protrusion 14e bends as the locking protrusion 14e is disengaged from the locking recess 16d, so that the lens cover 14 is unlocked. The holding projection 14c may be formed as mentioned above.

FIG. 11A illustrates a holding projection 14d according to one embodiment of the present invention. The holding projection is configured to slide into the recess 16b. The projection has a width 23 of about 1 cm and a length of at least 1 cm. The projection also has a sloping edge 29 for easy insertion into the recess, so that the opening of the recess 16b may be made smaller.

FIG. 11B illustrates a holding projection 14f according to another embodiment of the present invention. The holding projection 14f is provided with a narrower width 26 and a shorter length 28 than those of the holding projection 14d. These smaller dimensions minimize the possibility of the holding projection being bent and not inserted into the recess 16b. This smaller-sized holding projection 14f allows the opening of the recess 16b to be made smaller, so that it can be made less conspicuous to human eyes. In the present embodiment, the width 26 is about 3-5 mm and the length 28 (of the tip of the projection) is about 4-7 mm. The projection 14f also includes a sloping edge (not shown) to facilitate its insertion into the recess as with the projection 14d and a side portion or wing 30 that extends outwardly from the side of the lens cover 14. The wing 30 provides a greater contact area for the holding projection 14f while keeping the width 26 of the holding projection 14f to a minimum.

FIG. 11C shows a holding projection 14f according to yet another embodiment of the present invention. The holding projection 14f does not have a wing 30 unlike the holding projection 14f.

The video camera thus constructed is provided with the replaceable lens cover, and the lens cover can be replaced with another without using any special tool.

The present invention has been described using specific embodiments to enable those skilled in the art to understand and practice the invention. These embodiments may be changed or altered without departing from the scope of the invention. The scope of the invention should be defined using the appended claims.

1. A video camera comprising:
a lens unit to receive images to be captured;
a display device to display the captured images;
a main camera body; and
one or more exterior decorative components, each being configured to be removed and replaced with a corresponding decorative component having different appearance,
wherein one of the exterior decorative components includes a body and a first protrusion that extends outwardly from the body, and
wherein the main camera body defines a first recess that is configured to receive the first protrusion.

2. The video camera of claim 1, wherein the one exterior component defines a groove between the body of the exterior component and the first protrusion.

3. The video camera of claim 2, wherein the main camera body defines a step along a portion of the main camera body that is configured to receive the exterior component and provide the video camera with an even surface after the exterior component is placed on the portion of the main camera.

4. The video camera of claim 3, wherein the groove is configured to reduce an amount of light reflected outwardly via a space defined between the step and the exterior component, thereby making the first protrusion inserted into the first recess less visible to a user.

5. The video camera according to claim 1, wherein the replaceable exterior component is a lens cover provided on a lens barrel of the main camera body.

6. The video camera according to claim 5, wherein the lens cover includes a cylindrical front part, and substantially straight, semicylindrical rear legs.

7. The video camera according to claim 5, wherein the video camera further comprising;
a cylindrical fastener configured to be screwed into threads provided on an inner side of the lens barrel and secure the lens cover to the main camera body.

8. The video camera of claim 7, wherein the lens cover includes a cylindrical, front portion defining an inner diameter, wherein an outer diameter of the fastener is greater than the inner diameter of the lens cover.

9. The video camera of claim 7, wherein the fastener has a cylindrical shape and is configured to
press against the lens cover mounted on the main camera body to restrain a movement of the lens cover.

10. The video camera of claim 1, wherein the one exterior component includes a second protrusion that extends outwardly from the body of the exterior component, the second protrusion being configured to be received by a second recess defined on the main camera body.

11. The video camera of claim 10, wherein the one exterior component includes an upper portion and a side portion, the first protrusion being provided on the upper portion and the second protrusion being provided on the side portion.

12. The video camera of claim 11, wherein the second protrusion has a width of no more than 5 millimeter.

13. The video camera of claim 12, wherein the second protrusion has a backend that extends no more than 0.7 millimeter from a backend of the body of the one exterior component.

14. The video camera of claim 13, wherein the backend of the one exterior component includes a sloping edge.

15. The video camera of claim of claim 10, wherein the one or more exterior components includes a first exterior decorative component and a second exterior decorative component, the first exterior component being a lens cover and the second exterior component being a ring to hold the lens cover to a fixed position.

16. The video camera of claim 1, wherein the one exterior component is a lens cover, wherein the video camera is sold with a plurality of lens covers of different appearances, so the appearance of the video camera can be changed using the plurality of lens covers.

17. A video camera comprising:
a lens unit to capture images;
a display device to display the captured images;
a main camera body; and
at least one exterior decorative component that is configured to be removed and replaced with a corresponding decorative component having different appearance,
wherein the at least one exterior decorative components includes a body and a first protrusion that extends outwardly from the body,
wherein the main camera body defines a first recess that is configured to receive the first protrusion, and
wherein the one exterior component defines a groove between the body of the exterior component and the first protrusion, the groove being configured to make the first protrusion less visible to human eyes.

18. The video camera of claim 17, wherein the at least one exterior decorative component is a lens cover.

19. A lens cover for a video camera, the lens cover comprising:
a body having a cylindrical upper portion and a lower portion;
a holding projection extending outward from the lower portion of the body, the holding projection being configured to be received by a recess defined on a case of the video camera;
a groove defined between the lower portion of the body and the holding projection to make the holding projection less visible when the holding projection is inserted into the recess of the case,
wherein the lens cover is a removable, exterior decorative component of the video camera.
